(19) United States
(12) Patent Application Publication
(10) Pub. No.: US 2025/0323693 A1
(43) Pub. Date: Oct. 16, 2025

(54) PRECODING MATRIX DETERMINATION FOR NEAR-FIELD AND FAR-FIELD TRANSMISSIONS

(71) Applicant: ZTE Corporation, Shenzhen (CN)

(72) Inventors: Shujuan ZHANG, Shenzhen (CN); Yijian CHEN, Shenzhen (CN); Yuan SI, Shenzhen (CN); Yunlu WANG, Shenzhen (CN); Hongkang YU, Shenzhen (CN); Mengnan JIAN, Shenzhen (CN)

(21) Appl. No.: 19/253,016

(22) Filed: Jun. 27, 2025

Related U.S. Application Data
(63) Continuation of application No. PCT/CN2022/142856, filed on Dec. 28, 2022.

(51) Int. Cl. H04B 7/0456

(52) U.S. Cl. CPC H04B 7/0456

(57) ABSTRACT

Methods, apparatus, and systems that relate to determination of the precoding matrix are disclosed. In one example aspect, a method for digital communication includes determining, by a first communication node, a precoding matrix that is based on a first vector having N₁ elements. An element of the first vector is based on a first product of n and a first parameter, and a second product of n² and a second parameter. n is an integer that corresponds to an index of the element of the first vector and N₁ is a positive integer. The method also includes, by the first communication node, an indicator to a second communication node indicating the precoding matrix. The indicator includes information of at least one of the first parameter or the second parameter.

### CROSS-REFERENCE TO RELATED APPLICATION

This application is a continuation and claims priority to International Application No. PCT/CN2022/142856, filed on Dec. 28, 2022, the disclosure of which is hereby incorporated by reference herein in its entirety.

### TECHNICAL FIELD

This patent document is directed to digital communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to determining the precoding matrix for near-field and far-field transmissions.

In one example aspect, a method for digital communication includes determining, by a first communication node, precoding matrix that is based on a first vector having N₁ elements. An element of the first vector is based on a first product of n and a first parameter, and a second product of n² and a second parameter n corresponds to an index of the element of the first vector and N₁ is a positive integer. The method also includes, by the first communication node, an indicator to a second communication node indicating the precoding matrix. The indicator includes information of at least one of the first parameter or the second parameter.

In another example aspect, a method for digital communication includes receiving, by a second communication node, an indicator from a first communication node indicating a precoding matrix that is based on a first vector having N₁ elements. An element of the first vector is based on a first product of n and a first parameter, and a second product of n² and a second parameter, wherein n corresponds to an index of the element of the first vector and N₁ is a positive integer. The indicator includes information of at least one of the first parameter or the second parameter. The method also includes performing, by the second communication node, a transmission with the first communication node based on the precoding matrix.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

The disclosed techniques can be used to implement a precoding matrix that is suitable for both near field and far field communications, thereby allowing flexible switches between the different types of communications. In addition, the disclosed techniques provide example ways of determining certain parameters of the precoding matrix so as to reduce the signaling overhead for indicating the precoding matrix and to allow the precoding matrix to match a communication channel between two wireless communication nodes.

These, and other, aspects are described in the present document.

### BRIEF DESCRIPTION OF DRAWINGS

FIG. 1 illustrates an example transmitter having N transmitting antenna ports in accordance with one or more embodiments of the present technology.

FIG. 2 illustrates example mapping between the minimum value and the maximum value of the second parameter b corresponding to N in accordance with one or more embodiments of the present technology.

FIG. 3A is a flowchart representation of a method for wireless communication in accordance with one or more embodiments of the present technology.

FIG. 3B is a flowchart representation of another method for wireless communication in accordance with one or more embodiments of the present technology.

FIG. 4 shows an example of a wireless communication system where techniques in accordance with one or more embodiments of the present technology can be applied.

FIG. 5 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) New Radio (NR) or Sixth Generation (6G) standard for ease of understanding and the described technology may be implemented in different wireless system that implement protocols other than the NR or 6G protocol.

Beamforming is a signal processing technique used in sensor arrays for directional signal transmission or reception. Beamforming is achieved by combining elements in an antenna array in such a way that signals at particular angles experience constructive power while others experience destructive interference.

In wireless communications, beamforming can be achieved by a second communication node transmitting one or more reference signals to a first communication node (e.g., receiving reference signals on N×k reference signal ports, where N is associated with the number of transmitting elements/antenna ports of the transmitting node and k is a positive integer). The first communication node determines a precoding matrix based on the received measurement reference signals and indicates the precoding matrix to the second communication node. Then the second communication node can transmit signal to the first communication node based on the precoding matrix.

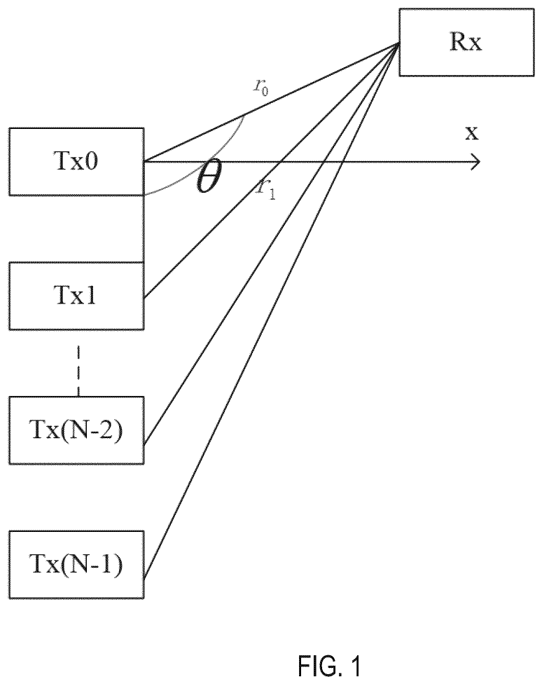

Beamforming also needs to account for different antenna configurations. For transmitting antennas, the near field and far field are regions of the electromagnetic field around an object. Near-field behaviors dominate when close to the antenna, while electromagnetic far-field behaviors dominate at greater distances. FIG. 1 illustrates an example transmitter having N transmitting elements/antenna ports in accordance with one or more embodiments of the present technology. For far-field communications, the distances between the adjacent transmitting antenna ports have little impact on the transmission and reception of the signals. For near-field communications, on the other hand, the distances between the adjacent transmitting elements/antenna ports can impact beamforming, thereby impacting the precoding matrix determined based on reference signal measurements.

This patent document discloses techniques that can be implemented to determine the precoding matrix for both near-field and far field communications independent of the antenna configurations of the transmitting node (e.g., the distances between the adjacent transmitting antenna ports). In some embodiments, for multi-layer transmissions, a precoding vector of the precoding matrix corresponding to one layer can be represented as:

$$W = [ \begin{matrix}{w}_{0} \\ {w}_{1} \\ ⋮ \\ {w}_{N - 1}\end{matrix} ] \qquad ( 1 )$$

An element in the precoding vector of the precoding matrix can be represented as:

$${w}_{n} = exp ( {+}_{-} j 2 π na {+}_{-} j 2 π {n}^{2} b ) , n = 0 , 1 , … N - 1 \qquad ( 2 )$$

Here, the precoding vector has N elements and n corresponds to an index of the element in the precoding vector. wₙ corresponds to a first part that is a product of a first parameter (e.g., a) and n, and a second part that is a product of a second parameter (e.g., b) and n², where 0≤a<1, 0≤b<1. The Equation (2) can be expressed in one of the following forms:

$${w}_{n} = exp ( j 2 π na - j 2 π {n}^{2} b ) , n = 0 , 1 , … N - 1 \qquad ( 2 a )$$

$${w}_{n} = exp ( - j 2 π na + j 2 π {n}^{2} b ) , n = 0 , 1 , … N - 1 \qquad ( 2 b )$$

$${w}_{n} = exp ( j 2 π na + j 2 π {n}^{2} b ) , n = 0 , 1 , … N - 1 \qquad ( 2 c )$$

$${w}_{n} = exp ( - j 2 π na - j 2 π {n}^{2} b ) , n = 0 , 1 , … N - 1 \qquad ( 2 d )$$

In some embodiments,

$$a = \frac{mO + q}{NO} ,$$

ma??{0, 1, . . . , N−1}, qa??{0???1 . . . , O−1}, where O is a positive integer. The value of b or the candidate values of b can be determined based on the value of N. For example, N can be indicated in a signaling from the base station to enable determination of the value of b (or the candidate values of b). The candidate values of b are independent from the antenna configuration of the transmitting node, and the elements of the precoding vector are independent of the antenna configuration of the transmitting node.

For example, referring back to FIG. 1, the channel between the n^{th} transmitting antenna of a transmitting node with N transmitting elements/antenna ports and a receiving node at angle ?? and distance r₀ can be expressed as follows:

$${h}_{n} = \frac{{r}_{0}}{{r}_{n}} exp ( - j \frac{2 π}{λ} ( {r}_{n} - {r}_{0} ) ) , n = 0 , 1 , … N - 1 \qquad ( 3 )$$

Here, the transmitter has N transmitting elements/antenna ports. ?? is the wavelength of the signal, rₙ is distance between the n^{th} transmitting element and the receiving node, and r₀ is the distance between a reference transmitting element and the receiving node. As shown in FIG. 1, the reference transmitting element can be the first transmitting antenna. Alternatively, one of the other transmitting antennas (e.g., the central transmitting antenna) can be selected as the reference transmitting element. The n^{th} element of a precoding vector can be represented as:

$${w}_{n} = {h}_{n}^{H} = \frac{{r}_{0}}{{r}_{n}} exp ( j \frac{2 π}{λ} ( {r}_{n} - {r}_{0} ) ) , n = 0 , 1 , … N - 1 \qquad ( 4 )$$

In some embodiments, when all the elements of the precoding vector have the same amplitude, the n^{th} element of the precoding vector can be expressed as:

$${w}_{n} = exp ( j \frac{2 π}{λ} ( {r}_{n} - {r}_{0} ) ) , n = 0 , 1 , … N - 1 \qquad ( 5 )$$

For simplicity, the subscript 0 of r₀ is omitted in the derivation steps below such that r=r₀.

$${r}_{n} = \sqrt{{r}^{2} + {( nd )}^{2} - 2 rnd sin ( ? ? )} , n = 0 , 1 , … N - 1 \qquad ( 6 )$$

Here, d denotes the distance between two adjacent transmitting elements. The value of rₙ can be approximated based on the equation below:

$${r}_{n} \approx r - nd sin θ + \frac{{( nd )}^{2} {cos}^{2} θ}{2 r} , n = 0 , 1 , … N - 1 \qquad ( 7 )$$

Then the n^{th} element of a precoding vector becomes the following:

$${w}_{n} = exp ( j \frac{2 π}{λ} ( - nda + {( nd )}^{2} \frac{{cos}^{2} θ}{2 r} ) ) , n = 0 , 1 , … N - 1 \qquad ( 8 )$$

In Equation (8), a first parameter a is used. In some embodiments,

$$a = \frac{mO + q}{NO} ,$$

ma??{0, 1, . . . , N−1}, qa??{0???1 . . . , O−1}.

Assuming that

$$d = \frac{? ?}{2}$$

(e.g., based on existing antenna configurations), Equation (8) can be simplified as:

$${w}_{n} = exp ( - j 2 π na + j {π ( n )}^{2} \frac{{cos}^{2} ( θ ) d}{2 r} ) ) , n = 0 , 1 , … N - 1 \qquad ( 9 - 1 )$$

A second parameter

$$b = \frac{1}{2 r} \times d or b = \frac{1}{2 r} \times \frac{d}{2}$$

can be used to further simplify Equation (9-1). In addition,

$$\frac{{cos}^{2} ( θ )}{2 r}$$

can be considered to be a fixed value for a group of vectors. Based on existing antenna configurations, it can be assumed that

$$0.62 \times \sqrt{\frac{{( Nd )}^{3}}{λ}} \leq r \leq \frac{2 {( Nd )}^{2}}{λ} and d = \frac{? ?}{2} .$$

Equation (9-1) can be further simplified into Equation (9-2) below:

$${w}_{n} = exp ( - j 2 π na + j 2 λ {n}^{2} b ) , n = 0 , 1 , … N - 1 \qquad ( 9 - 2 )$$

The range of candidate values of the second parameter b can be determined based on the value of N. For example,

$$\frac{1}{2 {N}^{2}} \leq b \leq \frac{1}{2.48 \sqrt{{( N / 2 )}^{3}}} \frac{1}{4 {N}^{2}} \leq b \leq \frac{1}{4.96 \sqrt{{( N / 2 )}^{3}}} .$$

The candidate values of b thus become independent from the distances between the adjacent transmitting antennas.

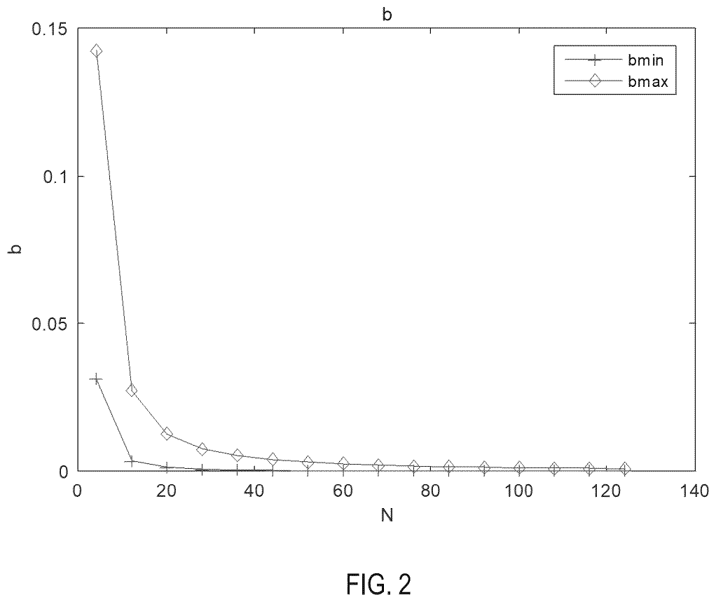

As shown in the example derivations above, the second parameter b can be determined by N. FIG. 2 illustrates example mapping between the minimum value and the maximum value of the second parameter b corresponding to N in accordance with one or more embodiments of the present technology. In some embodiments, the value range of b is inversely proportional to the value of N. The larger the N, the smaller the range of b, and the smaller of the maximum value of b. In some embodiments, the range of b refers to the range of candidate values of b. For example, the range of b equals to the difference between the minimum candidate value of b and the maximum candidate value of b.

In some implementation, the minimum value of b can be zero. The range of b equaling to the difference between the non-zero minimum candidate value of b and the maximum candidate value of b is inversely proportional to the value of N.

In some embodiments, a set of candidate values of b is determined by N. The larger the N, the larger the number of candidate values in the set. In some embodiments, the value difference (also referred to as a value gap) between two adjacent candidate values in the set is based on N. The larger the N, the smaller the value gap. The value of b corresponding to the precoding matrix can be determined by selecting a value from the set of candidate values.

In some embodiments, the minimum value of b is based on

$$\frac{1}{{N}^{2}} .$$

Fore example, or

$$\frac{1}{4 {N}^{2}} .$$

In some embodiments, the minimum value of b can be 0 (e.g., for far-field communications in which the impact of the second part in Equation (2) becomes negligible). In some embodiments, the UE receives a signaling that indicates whether the minimum value of b is 0 (e.g., far-field communication) or is based on

$$\frac{1}{{N}^{2}}$$

(e.g., near-field communication).

In some embodiments, the maximum value of b is based on

$$\frac{1}{\sqrt{{N}^{3}}} .$$

For example, the maximum value of b is or

$${b}_{m ax} = \frac{1}{4.96 \sqrt{{( N / 2 )}^{3}}} .$$

In some embodiments, the value of b is determined by at least one of following

$$b = {b}_{r} z + {b}_{1} , z ∈ [ 0 , 1 ) , or z ∈ [ 0 , 1 ] , \qquad ( 10 )$$

$$b = {b}_{r} \frac{y}{⌊ N \times x ⌋} + {b}_{1} , y ∈ \{ 0 , 1 , … , ⌊ N \times x ⌋ - 1 \} , \\ where x is a positive real number , \\ or \qquad ( 11 )$$

$$b = {b}_{r} \frac{y}{N \times x} + {b}_{1} , y ∈ \{ 0 , 1 , … , N \times x - 1 \} , \\ where x is a positive integer . \qquad ( 12 )$$

For example, bᵣ=(bₘₐₓ−bₘᵢₙ)z+bₘᵢₙ, where z represents a step size within the value range of b.

In some embodiments, the value of b is determined by at least one of following:

$$b = \frac{1}{{r}_{r} z + {r}_{1}} , z ∈ [ 0 , 1 ) , or z ∈ [ 0 , 1 ] , \qquad ( 13 )$$

$$b = \frac{1}{{r}_{r} \frac{Y}{⌊ N \times x ⌋} + {r}_{1}} , y ∈ \{ 0 , 1 , … , ⌊ N \times x ⌋ - 1 \} , \\ where x is a positive real number , \\ or \qquad ( 14 )$$

$$b = \frac{1}{{r}_{r} \frac{y}{N \times x} + {r}_{1}} , y ∈ \{ 0 , 1 , … , N \times x - 1 \} , \\ where x is a positive integer . \qquad ( 15 )$$

Here, rᵣ and r₁ are real numbers. In some embodiments, at least one of rᵣ or r₁ is a real number that is larger than or equal to 0.

In some embodiments, the value of x is determined based on N. For example, the UE can determine a mapping between x and N. In some embodiments, the larger the value of N, the smaller the value of x. In some embodiments, x>1.

In some embodiments, at least one of rᵣ or r₁ is determined based on the value of N and/or a signaling from the base station. The larger the N, the smaller at least one of r₁ or rᵣ. For example, a first value of r₁ and/or rᵣ associated with a first value of N is larger than a second value of r₁ and/or rᵣ associated with a second value of N. A first value of a number of candidate values of z associated with the first value of N is larger than a second value of a number of candidate values of z associated with the second value of N. A first value of b₁ and/or bᵣ associated with the first value of N is greater than a second value of b₁ and/or bᵣ associated with the second value of N. The first value of N is greater than the second value of N.

In some embodiments, once the value of N reaches a predefined threshold, the proportionality of the values of rᵣ, r₁, z, b₁, and/or bᵣ changes. For example, when N reaches a threshold T₀, a third value of r₁ and/or rᵣ associated with a third value of N is equal to or smaller than a fourth value of r₁ and/or rᵣ associated with a fourth value of N. A third value of a number of candidate values of z associated with the third value of N is equal to or smaller than a fourth value of the number of candidate values of z associated with the fourth value of N. A third value of b₁ and/or bᵣ associated with the third value of N is equal to or smaller than a fourth value of b₁ and/or bᵣ associated with the fourth value of N. The third value of N is greater than the fourth value of N.

In some embodiments, the value of bᵣ is determined based on N and/or a signaling from the base station. The larger the N, the smaller the range of bᵣ, and the smaller of the maximum value by bᵣ. In some embodiments, bᵣ is determined by at least one of

$$\frac{1}{{N}^{2}} \text{and/or} \frac{1}{\sqrt{{( N / 2 )}^{3}}} .$$

For example,

$${b}_{r} = \frac{1}{2.48 \sqrt{{( N / 2 )}^{3}}} - \frac{1}{2 {N}^{2}} or {b}_{r} = \frac{1}{4.96 \sqrt{{( N / 2 )}^{3}}} - \frac{1}{4 {N}^{2}} .$$

In some embodiments, the value of b₁ is determined by at least one of N and/or a received signaling from the base station. For example, the larger the N the smaller the b₁. In some embodiments, the value of b₁ is determined by

$$\frac{1}{{N}^{2}} .$$

For example

$${b}_{1} = \frac{1}{2 {N}^{2}} or {b}_{1} = \frac{1}{4 {N}^{2}} .$$

In some embodiments, the value of b₁ can be 0.

In some embodiments, if N is smaller than a threshold, the second parameter b is determined to be 0. In some embodiments, if the second parameter b is larger than 0, then N is greater than the threshold. In some embodiments, the second parameter b is determined based on N and/or a carrier index of CSI-RS corresponding to the precoding matrix. For example, the smaller the carrier index, the larger the value of b. For example, the threshold can be a value larger than 128.

In some embodiments, the UE determine a set of candidate values of the second parameter b. If the set includes more than one candidate value, the UE selects one or more values corresponding to the precoding matrix from the set of candidate values of the second parameter b and reports the determined one or more values of the second parameter b to the base station.

In some embodiments, the base station informs the UE of the candidate values of the first parameter a and/or the second parameter b. The UE can determine a candidate precoding vector set based on the candidate values, and further determine one or more precoding vectors based on the candidate precoding vector set.

In some embodiments, the base station informs the UE of the type of the set of candidate vectors. For example, the first type of candidate vectors has following format wₙ=exp (j2πna)), n=0, 1, . . . N−1 and the second type of candidate vectors has format of Equation (2) (e.g., one of Equation (2a), Equation (2b), Equation (2c) and/or Equation (2d)). The first type of candidate vectors can be a special case of the second type of vector in which the second parameter b is equal to 0.

In some embodiments, the UE receives a signaling from the base station, including information about the second parameter b. For example, the signaling includes the candidate values of b. The number of candidate values of b can include one or more different values. If the number of the candidate values of b is more than one, the UE can select one from the multiple candidate values and reports the selected value to the base station. Alternatively, or in addition, the signaling includes the candidate values of at least one of x, y, or z.

In some embodiments, in the above equations, n can be other values that correspond to an index of the element in the precoding vector. For example,

$$n = - N / 2 - N / 2 + 1 , … , 0 , 1 , … , N / 2 - 1.$$

In some embodiments, the value N in above derivations steps corresponds to half of the number of antennas of the transmitting node. For example, N is the number of antennas having one polarization. The UE can receive a CSI-RS reference signaling on N×k CSI-RS ports, where k=2. The precoding vector with N elements described above only corresponds to the first half of the 2×N CSI-RS port, or the second half of the 2×N CSI-RS port. The precoding vector described above can be referred to as a first vector. In some embodiments, the precoding vector has following format:

$${W}_{precoding} = [ \begin{matrix}{f}_{1} W \\ {f}_{2} W\end{matrix} ] \qquad ( 16 )$$

$${W}_{precoding} = [ \begin{matrix}W \\ {f}_{2} W\end{matrix} ] \qquad ( 17 )$$

In some implementation, one column corresponding to one layer of the precoding matrix is based on a third vector determined based on two vectors that include a first vector W₁ and a second vector W₂. The first vector W₁ includes N₁ elements and the second vector W₂ includes N₂ elements, where N₁ and N₂ are both equal to or greater than 1. In some embodiments, the sum of N₁ and N₂ is greater than 1. As an example, the third vector including N₁×N₂ elements can be represented based on one of Equations (18)-(20) below:

$${W}_{3} = [ \begin{matrix}{w}_{0 , 1} {W}_{2} \\ {w}_{1 , 1} {W}_{2} \\ a ? ? \\ {w}_{{N}_{1} - 1 , 1} {W}_{2}\end{matrix} ] \qquad ( 18 )$$

$${W}_{3} = [ \begin{matrix}{w}_{0 , 1} {W}_{2} \\ {w}_{1 , 1} {W}_{2} \\ a ? ? \\ {w}_{{N}_{1} - 1 , 1} {W}_{2}\end{matrix} ] + {W}_{12} \qquad ( 19 )$$

$${W}_{3} = [ \begin{matrix}{w}_{0 , 1} {W}_{2} \\ {w}_{1 , 1} {W}_{2} \\ a ? ? \\ {w}_{{N}_{1} - 1 , 1} {W}_{2}\end{matrix} ] - {W}_{12} \qquad ( 20 )$$

Here, w_{n,1}, n∈{0, 1, . . . N₁−1} is an element with an index n of the first vector W₁. The (n×N₂+m)-th element of W₁₂ is determined by a product of n and m W₁₂(n*N₂+rₙ)=exp(j2πnmb)W₁₂(n*N₂+m)=exp(j4πnmc).

An element with an index n of the first vector W₁ can be derived based on:

$${w}_{n} = exp ( {+}_{-} j 2 π {na}^{′} {+}_{-} j 2 π {n}^{2} {b}^{′} ) , n = 0 , 1 , … {N}_{1} - 1 \qquad ( 21 )$$

Equation (21) can also be expressed as any of the following:

$${w}_{n} = exp ( j 2 π {na}^{′} - j 2 π {n}^{2} {b}^{′} ) , n = 0 , 1 , … {N}_{1} - 1 \qquad ( 21 a )$$

$${w}_{n} = exp ( - j 2 π {na}^{′} + j 2 π {n}^{2} {b}^{′} ) , n = 0 , 1 , … {N}_{1} - 1 \qquad ( 21 b )$$

$${w}_{n} = exp ( - j 2 π {na}^{′} - j 2 π {n}^{2} {b}^{′ )} , n = 0 , 1 , … {N}_{1} - 1 \qquad ( 21 c )$$

$${w}_{n} = exp ( j 2 π {na}^{′} + j 2 π {n}^{2} {b}^{′} ) , n = 0 , 1 , … {N}_{1} - 1 \qquad ( 21 d )$$

An element with an index m of the second vector W₂ can be derived based on:

$${w}_{m} = exp ( + j 2 π {ma}^{″} + j 2 π {m}^{2} {b}^{″} ) , m = 0 , 1 , … {N}_{2} - 1 \qquad ( 22 )$$

Equation (22) can also be expressed as any of the following:

$${w}_{m} = exp ( j 2 π {ma}^{″} - j 2 π {m}^{2} {b}^{″} ) , m = 0 , 1 , … {N}_{2} - 1 \qquad ( 22 a )$$

$${w}_{m} = exp ( - j 2 π {ma}^{″} + j 2 π {m}^{2} {b}^{″} ) , m = 0 , 1 , … {N}_{2} - 1 \qquad ( 22 b )$$

$${w}_{m} = exp ( - j 2 π {ma}^{″} - j 2 π {m}^{2} {b}^{″} ) , m = 0 , 1 , … {N}_{2} - 1 \qquad ( 22 c )$$

$${w}_{m} = exp ( j 2 π {ma}^{″} + j 2 π {m}^{2} {b}^{″} ) , m = 0 , 1 , … {N}_{2} - 1 \qquad ( 22 d )$$

The first vector W₁ and the second vector W₂ share the same features of W described above which includes features in Equation (1) to (15). For example, the relationship between b′ and N₁ or between b″ and N₂ is similar to the relationship between the second parameter b and N. For example, Equations (10)-(15) can be used to derive b′ and/or b″.

In some implementation, W₁₂(n×N₂+2)=exp(j2πnm×b′), or W₁₂(n×N₂+2)=exp(j2πnm×b′), or W₁₂(n×N₂+2)=exp(j2πnm×f(b′,b″)). f(b′,b″) is a function of b′ and b″. For example, f(b′, b″)=2b′×b′.

In some embodiments, in the above equations, n can be other values that correspond to an index of the element in the precoding vector (or the first vector). For example, n=−N₁/2−N₁/2+1, . . . , 0, 1, . . . , N₁/2−1. m can be other values that correspond to an index of the element in the second vector

$$m = - \frac{{N}_{2}}{2} , - \frac{{N}_{2}}{2} + 1 , … , 0 , 1 , … , \frac{{N}_{2}}{2} - 1 \\ n = - {N}_{2} / 2 - {N}_{2} / 2 + 1 , … , 0 , 1 , … , {N}_{2} / 2 - 1.$$

In some embodiments, the one column vector corresponding to one layer of multi-layer transmissions of the precoding matrix includes 2×N₁×N₂ elements. The UE determines the precoding matrix based on received reference signals on 2×N₁×N₂ CSI-RS ports (e.g., k=2*N₂₎ The elements in the one column vector can be based on one or multiple third vectors. For example, the one column vector W_{precoding} corresponding to the one layer can be expressed using one of following formats:

$${W}_{precoding} = [ \begin{matrix}{f}_{1} {W}_{3} \\ {f}_{2} {W}_{3}\end{matrix} ] \qquad ( 23 )$$

$${W}_{precoding} = [ \begin{matrix}{W}_{3} \\ {f}_{2} {W}_{3}\end{matrix} ] \qquad ( 24 )$$

$${W}_{precoding} = [ \begin{matrix}{\sum }_{i = 0}^{L - 1} {f}_{1}^{i} {W}_{3}^{i} \\ {\sum }_{i = 0}^{L - 1} {f}_{2}^{i} {W}_{3}^{i}\end{matrix} ] \qquad ( 25 )$$

$${W}_{precoding} = [ \begin{matrix}{f}_{1} {W}_{3}^{1} \\ {f}_{2} {W}_{3}^{2}\end{matrix} ] \qquad ( 26 )$$

$${W}_{precoding} = [ \begin{matrix}{W}_{3}^{1} \\ {f}_{2} {W}_{3}^{2}\end{matrix} ] \qquad ( 27 )$$

$${W}_{precoding} = [ \begin{matrix}{\sum }_{i = 0}^{L - 1} {f}_{1}^{i} {W}_{3}^{i} \\ {\sum }_{i = 0}^{L - 1} {f}_{2}^{i} {W}_{3}^{L + i}\end{matrix} ] \qquad ( 28 )$$

Here, fᵢ, i=1, 2 and fᵢ^{j}, i=1, 2, j=0, 1 . . . L−1 represent a coefficient including one of amplitude, phase, or amplitude and phase. The difference between Equations (23)-(25) and Equations (26)-(28) is whether the two third vector groups including one for the first half CSI-RS ports and another the second half CSI-RS ports of W_{precoding} are different. For example, the vector groups are the same in Equations (23)-(25) and are different in Equations (26)-(28).

In some embodiments, the candidate values of b are included in more than one or more candidate sets. Different candidate sets can be determined by different ways. In some embodiments, different candidate sets are determined by different parameters or different values of same parameter. For example, the candidate values of b are included in two candidate sets. The first set includes value 0 (e.g., for far-field communications) and the second set is determined by at least one of Equation (10) to (15) (e.g., for near-field communications). Alternatively, the candidate values of b are included in three candidate sets. The first set includes value 0, the second set is determined by at least one of Equation (10) to (15) based on a first value of at least one of b₁, bᵣ, rᵣ, r₁, or x. The third set is determined by at least one of Equation (10) to (13) based on a second value of at least one of b₁, bᵣ, rᵣ, r₁, or x. In some embodiments, the UE receives signaling from the base station, indicating the value of at least one of b₁, bᵣ rᵣ, r₁, or x.

In some embodiments, if the value of a second parameter is determined by UE to be 0, then the UE reports a first set of CSI information (e.g., for far-field communications). If the value of the parameter is determined by UE to be non-zero, then the UE reports a second set of CSI information (e.g., for near-field communications). The first set of CSI information and the second set of CSI information can include different types of parameters and/or different number of bits. The parameters can be at least one of b, b′, or b″, or other parameters such as coefficient fᵢ or fᵢ^{j}. The UE can determine the second parameter to be 0 according to a received signaling from the base station. Alternative, or in addition, the UE can determine the second parameter to be 0 based on its own derivation. For example, the UE can determine that the second parameter is 0 by matching the channel between the base station and the UE. In some embodiments, the precoding matrix is far field precoding matrix when the second parameter is 0 and the precoding matrix is near field precoding matrix when the second parameter is larger than 0.

In some embodiments, different UEs can exchange information about the precoding matrix. For example, the UE can report the indicator of the precoding matrix to another UE.

In some embodiments, the base station can determine the precoding matrix based on the equations above without reporting from the UE. The base station can perform downlink signaling transmissions, such as Channel Station Information Reference Signal (CSI-RS), the Physical Downlink Shared Channel (PDSCH) or the Physical Downlink Control Channel (PDCCH), using a pre-determined precoding matrix. In some embodiments, the base station can determine the precoding matrix based on the sounding reference signal transmission from the UE.

In some embodiments, the base station informs the UE of the precoding matrix by including an indicator in a signaling message to the UE so that the UE can determine the precoding matrix based on the indicator. The UE then transmits uplink signal using the determined precoding matrix.

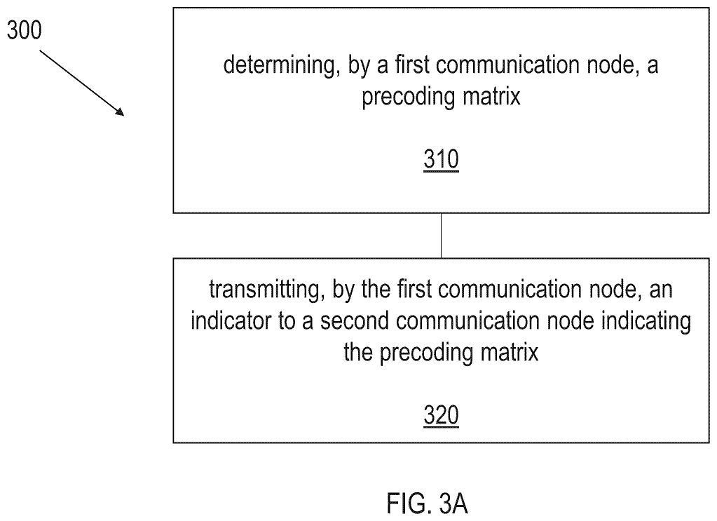

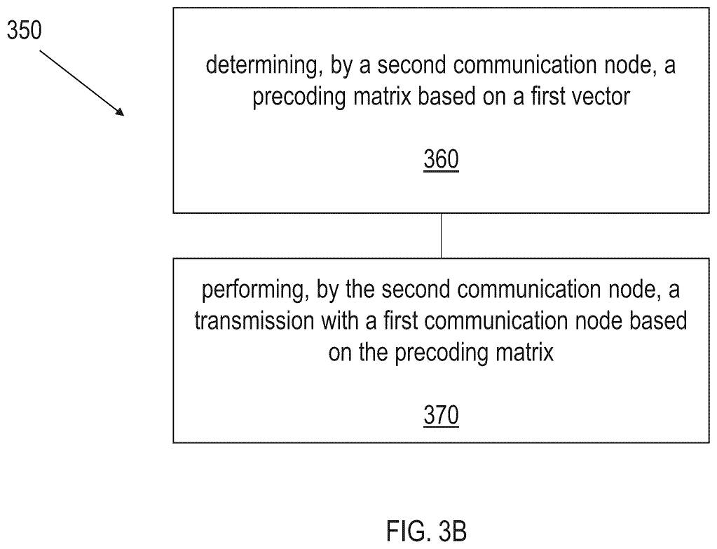

FIG. 3A is a flowchart representation of a method 300 for digital communication in accordance with one or more embodiments of the present technology. The method 300 includes, at operation 310, determining, by a first communication node, a precoding matrix that is based on a first vector having N₁ elements. An element of the first vector is based on a first product of n and a first parameter, and a second product of n² and a second parameter. n is an integer that corresponds to an index of the element of the first vector and N₁ is a positive integer. The method 300 includes at operation 320, transmitting, by the first communication node, an indicator to a second communication node indicating the precoding matrix. The indicator includes information of at least one of the first parameter or the second parameter.

In some embodiments, the method includes receiving, by the first communication node, reference signals from the second communication node on N₁×k reference signal ports, where k is a positive integer. The method also includes determine the precoding matrix based on the reference signals.

FIG. 3B is a flowchart representation of a method 350 for digital communication in accordance with one or more embodiments of the present technology. The method 350 includes, at operation 360, determining, by a second communication node, a precoding matrix based on a first vector having N₁ elements. An element of the first vector is based on a first product of n and a first parameter, and a second product of n² and a second parameter, wherein n is an integer that corresponds to an index of the element of the first vector N₁ is a positive integer. The indicator includes information of at least one of the first parameter or the second parameter. The method 350 also includes at operation 370, performing, by the second communication node, a transmission with the second communication node based on the precoding matrix.

In some embodiments, the method includes receiving, by the second communication node, an indicator from the first communication node indicating the precoding matrix. In some embodiments, the method includes transmitting, by the first communication node, reference signals on N₁×k reference signal ports to enable the second communication node to determine the precoding matrix, wherein k is a positive integer.

In some embodiments, the first vector is independent from a distance between adjacent antenna ports of the first wireless communication node or the second wireless communication node. In some embodiments, candidate values of the second parameter are independent from a distance between adjacent antenna ports of the first wireless communication node or the second wireless communication node.

In some embodiments, candidate values of the second parameter are specified based on one or more sets of values, wherein each set of values is based on a respective parameter indicated by the indicator or a respective value of a third parameter indicated by the indicator. In some embodiments, candidate values of the second parameter are determined by N₁. In some embodiments, a range of the candidate values of the second parameter is inversely proportional to N₁ such that the value range increases as a value of N₁ decreases. In some embodiments, the second parameter is 0 in case N₁ is smaller than a first threshold, and/or the second parameter is not 0 in case N₁ is greater than a second threshold. In some embodiments, a minimum value of the candidate values of the second parameter is inversely proportional to N₁², or a non-zero minimum value of the candidate values of the second parameter is inversely proportional to N₁². In some embodiments, a maximum value of the candidate values of the second parameter is inversely proportional to

$$\sqrt{{N}_{1}^{3}} .$$

In some embodiments, a number of the candidate values of the second parameter is proportional to N₁. In some embodiments, a value difference between two adjacent candidate values of the second parameter is inversely proportional to N₁.

In some embodiments, the information included in the indicator is associated with a type, and wherein the type associated with the information or a number of bits representing the information included in the indicator is based on a value of the second parameter. In some embodiments, candidate values of the second parameter are specified based on one or more value sets. In some embodiments, in case the value of the second parameter belongs to a first value set, the indicator includes a first set of parameters or a first number of bits. In some embodiments, in case the value of the second parameter belongs to a second value set, the indicator includes a second set of parameters or a second number of bits. In some embodiments, in case the second parameter is equal to 0, the indicator includes a first set of parameters or a first number of bits. In some embodiments, in case the second parameter is greater than 0, the indicator includes a second set of parameters or a second number of bits.

In some embodiments, the second parameter is indicated by a signaling message from the second wireless communication node to the first wireless communication node. In some embodiments, the signaling message comprises information indicating candidate values of the second parameter or a third parameter that is used to determine candidate values of the second parameter. In some embodiments, the second parameter being 0 indicates that the precoding matrix is associated with a far field communication. In some embodiments, the second parameter being greater than 0 indicates that the precoding matrix is associated with a near field communication. In some embodiments, the precoding matrix is applicable to multiple transmission layers. In some embodiments, the precoding matrix is applicable to one transmission layer of multiple transmission layers, wherein each of the multiple transmission layers corresponds to a respective precoding matrix.

In some embodiments, the element of the first vector corresponds to exp(±j2πna±j2πn²b), wherein the first parameter is denoted as a and the second parameter is denoted as b, wherein 0≤a<1 and 0≤b<1. In some embodiments, b is determined by at least one of:

$$b = {b}_{r} z + {b}_{1} , za \text{??} [ 0 , 1 ) , or , za \text{??} \text{[0,1],} \qquad ( 1 )$$

$$b = {b}_{r} \frac{y}{\vert N \times x \vert} + {b}_{1} , y ∈ \{ 0 , 1 , … , ⌊ N \times x ⌋ - 1 \} , \qquad ( 2 )$$

wherein x is a positive real number,

$$b = {b}_{r} \frac{y}{N \times x} + {b}_{1} , y ∈ \{ 0 , 1 , … , N \times x - 1 \} , \qquad ( 3 )$$

wherein x is a positive integer,

$$b = \frac{1}{{r}_{r} z + {r}_{1}} , za \text{??} [ 0 , 1 ) , or , za \text{??} [ 0 , 1 ] , \qquad ( 4 )$$

$$b = \frac{1}{{r}_{r} \frac{y}{⌊ N \times x ⌋} + {r}_{1}} , y ∈ \{ 0 , 1 , … , ⌊ N * x ⌋ - 1 \} , \qquad ( 5 )$$

where x is a positive real number;

$$b = \frac{1}{{r}_{r} \frac{y}{N * x} + {r}_{1}} , y ∈ \{ 0 , 1 , … , N * x - 1 \} , \qquad ( 6 )$$

where x is a positive integer; or (7) b=0, where 0<bᵣ<1, 0≤b₁<1, 0<rᵣ, 0<r₁, rᵣ and r₁ being real numbers.

In some embodiments, at least one of bᵣ, b₁, rᵣ, z or r₁ is determined by at least one of a signaling or N₁. In some embodiments, at least one of bᵣ, b₁, rᵣ, z or r₁ is determined by N₁, and the determining comprises at least one of: (1) a first value of at least one of rᵣ′ or r₁′ associated with a first value of N₁ is larger than a second value at least one of rᵣ′ or r₁′ associated with a second value of N₁; (2) a first value of a number of candidate values of z associated with a first value of N₁ is larger than a second value of the number of candidate values of z associated with a second value of N₁; or (3) a first value of at least one of bᵣ or b₁ associated with a first value of N₁ is smaller than a second value of at least one of bᵣ or b₁ associated with a second value of N₁, where the first value of N₁ is larger than the second value of N₁.

In some embodiments, the candidate values of the second parameter are based on N₁ and a carrier of a reference signal corresponding to the precoding matrix. In some embodiments, the precoding matrix is also based on a second vector with N₂ elements, where the element of the second vector is based on a third product of m and a third parameter and a fourth product of m² and a fourth parameter. m is an integer that corresponds to an index of the element of the second vector, and wherein N₂ is a positive integer. In some embodiments, candidate values of the fourth parameter are based on N₂. In some embodiments, the candidate values of the fourth parameter are based on N₂ and a carrier of a reference signal corresponding to the precoding matrix.

In some embodiments, the first communication node comprises a user equipment, and wherein the second communication node comprises a base station. In some embodiments, the first communication node comprises a first user equipment and the second communication node comprises a second user equipment.

In some embodiments, n is one of: (1) n=0, 1, . . . , N₁−1, wherein element is n; (2) n=1, . . . , N₁−1, wherein the index of the element is n; or

$$na \text{??} [ \frac{- {N}_{1}}{2} , \frac{{N}_{1}}{2} - 1 ] , \qquad ( 3 )$$

wherein the index of the element is

$$n + \frac{{N}_{1}}{2} .$$

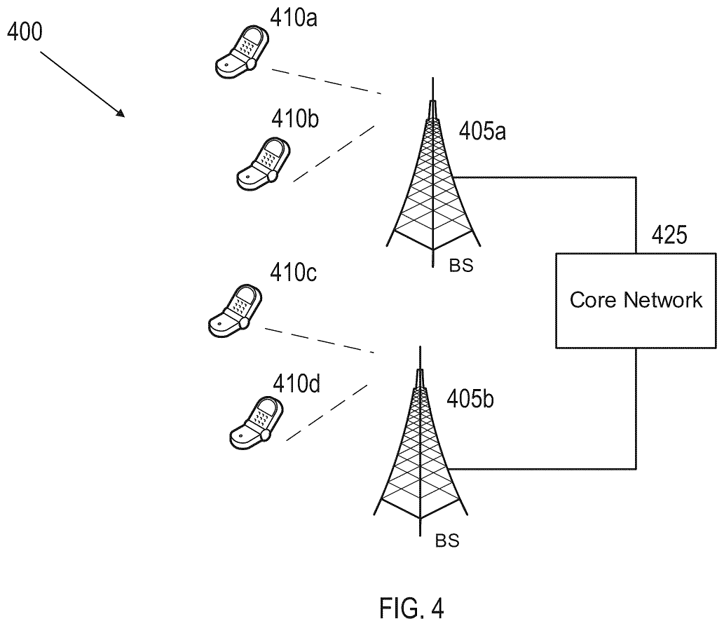

FIG. 4 shows an example of a wireless communication system 400 where techniques in accordance with one or more embodiments of the present technology can be applied. A wireless communication system 400 can include one or more base stations (BSs) 405a, 405b, one or more wireless devices (or UEs) 410a, 410b, 410c, 410d, and a core network 425. A base station 405a, 405b can provide wireless service to user devices 410a, 410b, 410c and 410d in one or more wireless sectors. In some implementations, a base station 405a, 405b includes directional antennas to produce two or more directional beams to provide wireless coverage in different sectors. The core network 425 can communicate with one or more base stations 405a, 405b. The core network 425 provides connectivity with other wireless communication systems and wired communication systems. The core network may include one or more service subscription databases to store information related to the subscribed user devices 410a, 410b, 410c, and 410d. A first base station 405a can provide wireless service based on a first radio access technology, whereas a second base station 405b can provide wireless service based on a second radio access technology. The base stations 405a and 405b may be co-located or may be separately installed in the field according to the deployment scenario. The user devices 410a, 410b, 410c, and 410d can support multiple different radio access technologies. The techniques and embodiments described in the present document may be implemented by the base stations of wireless devices described in the present document.

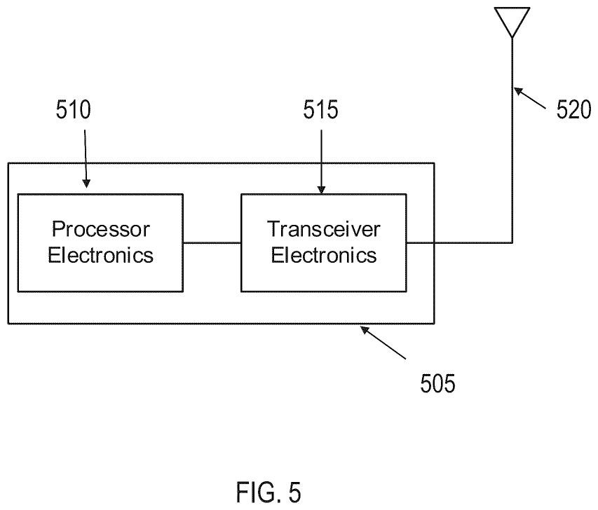

FIG. 5 is a block diagram representation of a portion of a radio station in accordance with one or more embodiments of the present technology can be applied. A radio station 505 such as a network node, a base station, or a wireless device (or a user device, UE) can include processor electronics 510 such as a microprocessor that implements one or more of the wireless techniques presented in this document. The radio station 505 can include transceiver electronics 515 to send and/or receive wireless signals over one or more communication interfaces such as antenna 2020. The radio station 505 can include other communication interfaces for transmitting and receiving data. Radio station 505 can include one or more memories (not explicitly shown) configured to store information such as data and/or instructions. In some implementations, the processor electronics 510 can include at least a portion of the transceiver electronics 515. In some embodiments, at least some of the disclosed techniques, modules or functions are implemented using the radio station 505. In some embodiments, the radio station 505 may be configured to perform the methods described herein.

It can be appreciated that the disclosed techniques can be used to implement a precoding matrix suitable for both near-field and far-field communications and enable flexible switches between the new-field and far-field communications. The disclosed techniques further provide mechanisms to determine certain parameters of the precoding matrix that is a good match for a communication channel between two wireless communication nodes so as to reduce the signaling overhead.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
determining, by a first communication node, a precoding matrix,
wherein the precoding matrix is based on a first vector having N₁ elements, wherein an element of the first vector is based on a first product of n and a first parameter, and a second product of n² and a second parameter, wherein n is an integer that corresponds to an index of the element of the first vector, and wherein N₁ is a positive integer; and
transmitting, by the first communication node to a second communication node, an indicator indicating the precoding matrix, wherein the indicator includes information of at least one of the first parameter or the second parameter.

2. The method of claim 1, wherein candidate values of the second parameter are:
specified based on one or more sets of values, wherein each set of values is based on a respective parameter indicated by the indicator or a respective value of a third parameter indicated by the indicator;
or determined by N₁.

3. The method of claim 2, wherein a range of the candidate values of the second parameter is inversely proportional to N₁ such that the value range increases as a value of N₁ decreases.

4. The method of claim 2, wherein
a minimum value of the candidate values of the second parameter is inversely proportional to N₁²,
a non-zero minimum value of the candidate values of the second parameter is inversely proportional to N₁²,
a maximum value of the candidate values of the second parameter is inversely proportional to
$$\sqrt{{N}_{1}^{3}} ,$$
or
a number of the candidate values of the second parameter is proportional to N₁.

5. The method of claim 4, wherein a value difference between two adjacent candidate values of the second parameter is inversely proportional to N₁.

6. The method of claim 1, wherein the information included in the indicator is associated with a type, and wherein the type associated with the information or a number of bits representing the information included in the indicator is based on a value of the second parameter.

7. The method of claim 6, wherein candidate values of the second parameter are specified based on one or more value sets,
wherein, in case the value of the second parameter belongs to a first value set, the indicator includes a first set of parameters or a first number of bits,
wherein, in case the value of the second parameter belongs to a second value set, the indicator includes a second set of parameters or a second number of bits.

8. The method of claim 6,
wherein, in case the second parameter is equal to 0, the indicator includes a first set of parameters or a first number of bits,
wherein, in case the second parameter is greater than 0, the indicator includes a second set of parameters or a second number of bits.

9. The method of claim 1,
wherein the second parameter is indicated by a signaling message from the second wireless communication node to the first wireless communication node, or
wherein the signaling message comprises information indicating candidate values of the second parameter or a third parameter that is used to determine candidate values of the second parameter.

10. The method of claim 1, wherein the precoding matrix is applicable to multiple transmission layers.

11. The method of claim 1, wherein the precoding matrix is applicable to one transmission layer of multiple transmission layers, wherein each of the multiple transmission layers corresponds to a respective precoding matrix.

12. The method of claim 1, wherein the element of the first vector corresponds to exp(±j2πna±j2πn²b), wherein the first parameter is denoted as a and the second parameter is denoted as b, wherein 0≤a<1 and 0≤b<1.

13. The method of claim 12, wherein b is determined by at least one of:
$$b = {b}_{r} z + {b}_{1} , z ∈ [ 0 , 1 ) , or , z ∈ [ 0 , 1 ] \qquad ( 1 )$$
$$b = {b}_{r} \frac{y}{⌊ N \times x ⌋} + {b}_{1} , y ∈ \{ 0 , 1 , … , ⌊ N \times x ⌋ - 1 \} , \qquad ( 2 )$$
wherein X is a positive real number,
$$b = {b}_{r} \frac{y}{⌊ N \times x ⌋} + {b}_{1} , y ∈ \{ 0 , 1 , … , N \times x - 1 \} , \qquad ( 3 )$$
wherein X is a positive integer,
$$b = \frac{1}{{r}_{r} z + {r}_{1}} , z ∈ [ 0 , 1 ) , or , z ∈ [ 0 , 1 ] , \qquad ( 4 )$$
$$b = \frac{1}{{r}_{r} \frac{y}{⌊ N \times x ⌋} + {r}_{1}} , y ∈ \{ 0 , 1 , … , ⌊ N \times x ⌋ - 1 \} , \qquad ( 5 )$$
where x is a positive real number;
$$b = \frac{1}{{r}_{r} \frac{y}{N \times x} + {r}_{1}} , y ∈ \{ 0 , 1 , … , N \times x - 1 \} , \qquad ( 6 )$$
where x is a positive integer; or
(7) b=0,
wherein 0<bᵣ<1, 0≤b₁<1, 0<rᵣ, 0<r₁, rᵣ and r₁ being real numbers.

14. The method of claim 13, wherein at least one of bᵣ, b₁, rᵣ, z or r₁ is determined by at least one of a signaling or N₁.

15. The method of claim 13, wherein at least one of bᵣ, b₁, rᵣ, z or r₁ is determined by N₁, wherein the determining comprises at least one of:
a first value of at least one of rᵣ′ or r₁′ associated with a first value of N₁ is larger than a second value at least one of rᵣ′ or r₁′ associated with a second value of N₁;
a first value of a number of candidate values of z associated with a first value of N₁ is larger than a second value of the number of candidate values of z associated with a second value of N₁; or
a first value of at least one of bᵣ or b₁ associated with a first value of N₁ is smaller than a second value of at least one of bᵣ or b₁ associated with a second value of N₁,
wherein the first value of N₁ is larger than the second value of N₁.

16. A method for wireless communication, comprising:
determining, by a second communication node, a precoding matrix based on a first vector having N₁ elements, wherein an element of the first vector is based on a first product of n and a first parameter, and a second product of n² and a second parameter, wherein n is an integer that corresponds to an index of the element of the first vector, and wherein N₁ is a positive integer; and
performing, by the second communication node, a transmission with a first communication node based on the precoding matrix.

17. The method of claim 16, wherein
candidate values of the second parameter are:
specified based on one or more sets of values, wherein each set of values is based on a respective parameter indicated by the indicator or a respective value of a third parameter indicated by the indicator, or
candidate values of the second parameter is determined by N₁.

18. A first communication node comprising at least one processor configured to cause the first communication node to perform a method comprising:
determining, by the first communication node, a precoding matrix,
wherein the precoding matrix is based on a first vector having N₁ elements, wherein an element of the first vector is based on a first product of n and a first parameter, and a second product of n² and a second parameter, wherein n is an integer that corresponds to an index of the element of the first vector, and wherein N₁ is a positive integer; and
transmitting, by the first communication node to a second communication node, an indicator indicating the precoding matrix, wherein the indicator includes information of at least one of the first parameter or the second parameter.

19. The first communication node of claim 18, wherein candidate values of the second parameter are:
specified based on one or more sets of values, wherein each set of values is based on a respective parameter indicated by the indicator or a respective value of a third parameter indicated by the indicator, or
determined by N₁.

20. A second communication node comprising at least one processor configured to cause the second communication node to perform a method comprising:
determining, by the second communication node, a precoding matrix based on a first vector having N₁ elements, wherein an element of the first vector is based on a first product of n and a first parameter, and a second product of n² and a second parameter, wherein n is an integer that corresponds to an index of the element of the first vector, and wherein N₁ is a positive integer; and
performing, by the second communication node, a transmission with a first communication node based on the precoding matrix.
